(19) United States
(12) Patent Application Publication
(10) Pub. No.: US 2001/0036214 A1
(43) Pub. Date: Nov. 1, 2001

(54) Method and apparatus for in-situ deposition of epitaxial thin film of high-temperature superconductors and other complex oxides under high-pressure

(76) Inventors: Ivan Bozovic, Palo Alto, CA (US); Gennadi Logvenov, Lilienthal (DE); Vladimir Matijasevic, Santa Fe, NM (US); Martin A. J. Verhoeven, Bremen (DE)

Correspondence Address: IOTA PI LAW GROUP, 350 CAMBRIDGE AVENUE SUITE 250, P O BOX 60850, PALO ALTO, CA, 94306-0850, US

(21) Appl. No.: 09/766,182

(22) Filed: Jan. 18, 2001

Related U.S. Application Data
(60) Provisional application No. 60/178,761, filed on Jan. 28, 2000.

(51) Int. Cl. H01S 3/22; H01S 3/223

(52) U.S. Cl. 372/55

(57) ABSTRACT

An apparatus and a method is disclosed for in-situ deposition of thin films of high-temperature superconductor (HTS) compounds on a substrate that involves exposure of the substrate to a high pressure of oxygen and/or a high vapor pressure of volatile metallic elements such as Hg, Tl, Pb, Bi, K, Rb, etc., for stabilization of the crystal structure. Such compounds include basically all known HTS materials with T_{c} higher than 100 K. The method is based on pulsed laser deposition (PLD) and a cyclic (periodic) process, wherein the substrate is shuttled between a “closed” and an “open” position. In the “closed” position it is exposed to high temperature and high pressure of oxygen and/or volatile metallic species. In the “open” position, it is kept under low pressure and exposed to PLD plume. Short deposition bursts occur while the substrate is in the open position. These are followed by longer time intervals of re-crystallization and structural relaxation, which occur while the substrate is in the “closed” position.

This application claims priority to U.S. Provisional Application No. 60/178,761, filed Jan. 28, 2000, which is incorporated in its entirety herein by reference.

### FIELD OF THE INVENTION

The present invention relates to an apparatus and method for in-situ deposition of HTS compounds on a substrate that involves exposure of the substrate to a high pressure of oxygen and/or a high vapor pressure of volatile metallic elements such as Hg, Tl, Pb, Bi, K, Rb, etc., for stabilization of the crystal structure.

### Documents

[1] A. Schilling, M. Cantoni, J. D. Gao and H. R Ott, “Superconductivity above 130 K in the Hg—Ba—Ca—Cu—O system”, Nature 363 (1993) 56-58.

[2] C. W. Chu, L. Gao, F. Chen, Z. J. Huang, R. L. Meng and Y. Y. Xue, “Superconductivity above 150 K in HgBa₂Ca₂Cu₃O_{8+δ} at high pressures”, Nature 365 (1993) 323-325.

[3] L. Gao, Y. Y. Xue, F. Chen, Q. Xiong, R. L. Meng, D. Ramirez and C. W. Chu, “Superconductivity up to 164 K in HgBa₂Caₘ₋₁CUₘO_{2m+2+d} (m=1, 2 and 3) under quasihydrostatic pressures”, Physical Review B 50 (1994) 4260-4263.

[4] C. C. Tsuei, A. Gupta, G. Trafas, and D. Mitzi, “Superconducting mercury-based cuprate films with a zero-resistance transition temperature of 124 Kelvin”, Science 263 (1994) 1259-1261.

[5] H. Higuma, S. Miyashita, F. Uchikawa, “Synthesis of superconducting Pb-doped HgBa₂CaCu₂O_{y} films by laser ablation and post-annealing”, Applied Physics Letters 65 (1994) 743-5.

[6] W. N. Kang, R. L. Meng and C. W. Chu, “Growth of HgBa₂Ca₂Cu₃O₈ thin films using stable Re_{0.1}Ba₂Ca₂Cu₃Oₓ precursor by pulsed laser deposition”, Applied Physics Letters 73 (1998) 381-3.

[7] A. Tsukamoto, K. Takagi, Y. Moriwaki, T. Sugano, S. Adachi, K. Tanabe, “High-performance (Hg, Re)Ba₂CaCu₂O_{y} grain-boundary Josephson junctions and dc superconducting quantum interference devices”, Applied Physics Letters 73 (1998) 990-2.

[8] S. L. Yan, Y. Y. Xie, J. Z. Wu, T. Aytug, A. A. Gapud, B. W. Kang, L. Fang, M. He, S. C. Tidrow, K. W. Kircher, J. R. Liu, W. K. Chu, “High critical current density in epitaxial HgBa₂CaCu₂Oₓ thin films”, Applied Physics Letters 73 (1998) 2989-91.

[9] J. Z. Wu, S. L. Yan, Y. Y. Xie, “Cation exchange: A scheme for synthesis of mercury-based high-temperature superconducting epitaxial thin films”, Applied Physics Letters 74 (1998) 1469-71.

[10] V. Matijasevic and I. Bozovic, “Thin Film Processes for High-Temperature Superconductors”, Current Opinion in Solid State and Materials Science 1 (1996) 47-56.

[11] M. P. Siegal, N. Missert, E. L. Venturini, P. P. Newcomer, F. Dominguez, R. Dunn: “Growth of TlBa₂CaCU₂O₇ thin films using a controlled Tl-oxide source during processing”, IEEE Transactions on Applied Superconductivity 5 (1995) 1343-1346.

[12] M. A. Alario-Franco, P. Bordet, J. J. Caponi, C. Chaillout, J. Chenavas, T. Fournier, M. Marezio, S. de Brion, B. Souletie, A. Sulpice, J. L. Tholence, C. Colliex, R. Argoud, J. L. Baldonedo, M. F. Gorius, M. Perroux, “‘Copper-carbonate cuprates’: a new family of HTSC mixed oxides”, Physica C 235-240 (1994) 975-6.

[13] H. Ihara, K. Tokiwa, A. Iyo, M. Hirabayashi, N. Terada, M. Tokumoto, Y. S. Song, “New High-T_{c} Superconductor Families of Ag₁₋ₓCuₓBa₂Caₙ₋₁CuₙO_{2n+3-y} and CuBa₂Caₙ₋₁CuₙO_{2n+4-y} with T_{c}>116K”, Physica C 235-240 (1994) 981-2.

[14] H. Ihara, K. Tokiwa, H. Ozawa, M. Hirabayashi, A. Negishi, H. Matuhata, Y. S. Song, “New High-T_{c} Superconductor Family of Cu-Based Cu₁₋ₓBa₂Caₙ₋₁CuₙO_{2n-4-δ} with T_{c}>116K”, Japanese Journal of Applied Physics 33 (1994) L503-6.

[15] J. Ramirez-Castellanos, Y. Matsui, T. Kawashima, E. Takayama-Muromachi, A. I. Kirkland, “New Compound Sr₃Ca₃Cu₆O_{12±δ} with Modulated Superstructure”, Japanese Journal of Applied Physics 34 (1995) L1591-3.

[16] S. K. Agarwal, A. Iyo, K. Tokiwa, Y. Tanaka, M. Tokumoto, N. Terada, T. Saya, M. Umeda, H. Ihara, M. Hamao, T. Watanabe, A. V. Narlikar, “Superconductivity in the Mg-doped CuBa₂Ca₃Cu₄O_{12-y} system”, Physical Review B 58 (1998) 9504-9.

[17] K. Tokiwa, Y. Tanaka, A. Iyo, Y. Tsubaki, K. Tanaka, J. Akimoto, Y. Oosawa, N. Terada, M. Hirabayashi, M. Tokumoto, S. K. Agarwal, T. Tsukamoto, H. Ihara, “High pressure synthesis and characterization of single crystals of CuBa₂Ca₃Cu₄O_{y} superconductor”, Physica C 298 (1998) 209-16.

[18] Mun-Seog Kim, Sung-Ik Lee, A. Iyo, K. Tokiwa, M. Tokumoto, H. Ihara, “Interlayer coupling and superconducting properties of the triple-layer compound B_{0.6}C_{0.4}(Sr_{0.25}Ba_{0.75})₂Ca₂Cu₃O₉”, Physical Review B 57 (1998) 8667-70.

[19] C. Kunugi, S. Kuwata, K. Tokiwa, A. Iyo, T. Watanabe, H. Ihara, “Pressure effect on T_{c} in (B₁₋ₓCₓ) (Ba_{1-y}Sr_{y})₂Ca₂Cu₃O_{z} (x=0.3, y=0.25; x=0.35, y=0.3) and B_{0.8}C_{0.2}(Ba_{0.75}Sr_{0.25})₂Ca₃Cu₄O_{z}”, Physica C 307 (1998) 17-22.

[20] H. Kinder, R. Semerad, P. Berberich, B. Utz and W. Prusseit, “Very large area YBa₂Cu₃O_{7-δ} film deposition”, in “Oxide Superconductors: Physics and Nanoengineering II”, SPIE Proceedings 2697 (SPIE, Bellingham, 1996) I. Bozovic and D. Pavuna, editors, pp. 154-59.

[21] V. C. Matijasevic and P. Slycke, “Reactive evaporation technology for fabrication of YBCO wafers for microwave applications”, in “Superconducting and Related Oxides: Physics and Nanoengineering III”, SPIE Proceedings 3481 (SPIE, Bellingham, 1998) I. Bozovic and D. Pavuna, editors, pp. 190-6.

[22] D. Dijkamp, T. Venkatesan, X. D. Wu, S. A. Shaheen, N. Jisrawi, “Preparation of Y—Ba—Cu oxide superconductor thin films using pulsed laser evaporation from bulk high T_{c} material”, Applied Physics Letters 51 (1987) 619-21.

[23] X. D. Wu, D. Dijkkamp, S. B. Ogale, A. Inam, E. W. Chase, “Epitaxial ordering of oxide superconductor thin films on (100) SrTiO₃ prepared by pulsed laser ablation”, Applied Physics Letters 51 (1987) 861-3.

[24] G. Brorsson, Z. Ivanov and P. -Å. Nilsson, “In situ YBCO thin films made by laser deposition”, in “Science and Technology of Thin Film Superconductors II”, edited by R. McConnell and S. Wolf (Plenum, N.Y., 1990) pp. 169-75.

[25] D. K. Fork, G. A. N. Connell, D. B. Fenner, J. B. Boyce, Julia M. Phillips and T. H. Geballe, “YBCO films and YSZ buffer layers grown in situ on silicon by pulsed laser deposition”, in “Science and Technology of Thin Film Superconductors II”, edited by R. McConnell and S. Wolf (Plenum, N.Y., 1990) pp. 187-96.

[26] N. J. Ianno, D. Thompson, B. Johs, S. H. Liou and John A. Woollam, “Pulsed laser deposition of Tl—Ca—Ba—Cu—O films at 248 nm”, in “Science and Technology of Thin Film Superconductors II”, edited by R. McConnell and S. Wolf (Plenum, N.Y., 1990) pp. 205-14.

[27] D. C. Paine and J. C. Bravman, editors, “Laser Ablation for Materials Synthesis”, MRS Proceedings vol. 191 (MRS, Pittsburgh, 1990) and references therein.

### BACKGROUND OF THE INVENTION

For most electronics applications of high-temperature superconductors (HTS), one would like to have thin HTS films with as high a critical temperature (T_{c}) as possible. Based solely on this criterion, one would tend to favor films of the compound HgBa₂Ca₂Cu₃O₈, which today holds the record at both the ambient pressure (T_{c}=134 K) [1] and under a high pressure (T_{c}=164 K) [2, 3]. Indeed, with this motivation, a number of groups have grown thin films of HgBa₂Ca₂CU₃O₈, and other closely related phases. [4-8]

However, the second important criterion is the overall film quality, measured by its compositional uniformity, crystallinity, morphology, and ultimately, its transport properties. Generally, this criterion favors epitaxial films grown by one or another of in-situ deposition techniques. [9] These are methods for fabrication of HTS thin films that involve formation of the cuprate crystal structure during film deposition.

Historically, the processes that were developed first, required a post-deposition anneal, or simply post-anneal, in order to crystallize the material. They are still used for compounds such as HgBaCaCuO [4-8], or TlBaCaCuO [10], where the in-situ processes are difficult to implement because of the high vapor pressures of Hg and Tl. The main drawback of such methods is that re-crystallization during the post-anneal tends to generate polycrystalline films, with inferior morphology and transport properties. Even more important is the fact that such processes are not well suited for fabrication of multilayer structures, and are thus less interesting from the technological view point, for electronics applications.

Instability of the targeted compound under the thermodynamic conditions (pressure, temperature) accessible during a thin-film deposition experiment is a generic problem, encountered with basically all HTS compounds with T_{c} above 100 K. Some of these actually require high oxygen pressure (up to several tens of kbar) to be synthesized in the bulk form. [10-17] Others also involve volatile metallic species, such as Hg, Tl, Bi, or Pb.

It is thus of substantial technological interest to devise a method for in-situ deposition of thin HTS films which involve volatile cations or require high oxygen pressure for stabilization of the crystal structure. This is the subject of the method and apparatus of the present invention.

Another development related to the present invention is use of a higher-pressure oxygen “pocket” for in situ deposition of large-area YBa₂Cu₃O₇ films. [20, 21] Kinder et al. [20] and Matijasevic and Slycke [21] use thermal co-evaporation and a special heater assembly where the substrate onto which the film is deposited is rotated so that YBCO is first deposited under a very low pressure (typically 10⁻⁵ Torr), and then rotated under a cavity with a moderately high oxygen pressure (typically 10⁻²-10⁻¹ Torr). The opening between the substrate holder and the higher-pressure heater sub-chamber is very narrow (typically less than 0.5 mm), which allows for a substantial differential pumping.

While using a similar general principle, the method and the apparatus of the present invention contain some substantial differences and several detailed technical innovations, as expounded in what follows.

### SUMMARY OF THE INVENTION

One principal difference between the apparatus of the present invention and that of Kinder et al. [20] and Matijasevic and Slycke [21] is that our apparatus is based on pulsed laser deposition (PLD). This technique has been applied to HTS compounds soon after their discovery in [22, 23] and thereafter used extensively by many groups. [24-27]. Here, the material is ablated from the target and deposited onto the substrate in very short bursts, in the 10-100 nanosecond range. Since the laser repetition rate is low, typically 10-50 Hz, this means that short deposition intervals are followed by much longer (1-10 milliseconds) “passive” intervals in which the material may undergo re-crystallization and relaxation.

Another distinctive feature of PLD of HTS films is that it is generally performed under a significantly higher oxygen pressure, with p=100 mTorr being typical. Making use of this, our invention provides an improved differential pumping scheme to reach pressures as high as 1-10 bar, and even higher, during the oxidation and re-crystallization part of the growth cycle, as expounded in what follows. This is an improvement by a factor of 10,000-100,000 over the methods presently employed. This improvement enables one to access phases and compounds that are otherwise unstable and would not grow well in the desired epitaxial thin film form.

Still another important difference and innovation is that during the re-crystallization part of the cycle, we are exposing the growing film also to a very high vapor pressure of volatile metallic species, such as Hg, Tl, Pb, Bi, K, Rb, etc. This has not been done before. This is also critical insofar that it also allows one to expand the range of compounds that can be grown in-situ, in the preferred epitaxial thin film form. Also important is the fact that this expanded range of compounds includes the HTS compounds with the highest known critical temperatures.

These and other objects and features of the invention will become more fully apparent when the following detailed description of the invention is read in conjunction with the accompanying drawings.

### BRIEF DESCRIPTION OF THE FIGURES

FIG. 1 is a schematic diagram of a pulsed laser deposition (PLD) system with a single-stage, linear-motion, high-pressure heater assembly, constructed in accordance with embodiments of the invention.

FIG. 2 is a schematic diagram of a single-stage, circular-motion, high-pressure heater assembly, constructed in accordance with embodiments of the invention.

FIG. 3 is a schematic diagram of a PLD system with a two-stage differentially pumped linear-motion high-pressure heater assembly.

### DETAILED DESCRIPTION OF THE INVENTION

In order to grow high-quality epitaxial films of the “high-pressure” oxide phases described above, one needs to expose the sample during the growth (“in-situ”) to a high partial pressure (say 0.1-10 bar) of a gas such as molecular oxygen (or ozone, atomic oxygen, NO₂, a mixture of two or more of these gases, or some other suitable gaseous source of oxygen) and/or the high vapor pressure of one or more of volatile elements (such as Hg, Tl, Pb, Bi, K, Rb, etc.) On the other hand, for proper operation of the PLD apparatus, it is necessary to keep the laser ablation target at a relatively low pressure (say, 100 mTorr). In order to simultaneously satisfy these two seemingly contradictory conditions, we have designed an apparatus described in what follows.

A vacuum chamber suitable for PLD is provided with one or more pumps (such as a turbo-molecular pump or a cryo-pump provided with a backing mechanical pump), a plurality of ports including optical windows, sample introduction port, feedthroughs for gas lines, water lines, and electrical connections, as well as mechanical supports for the heater assembly, the target, and the substrate holder.

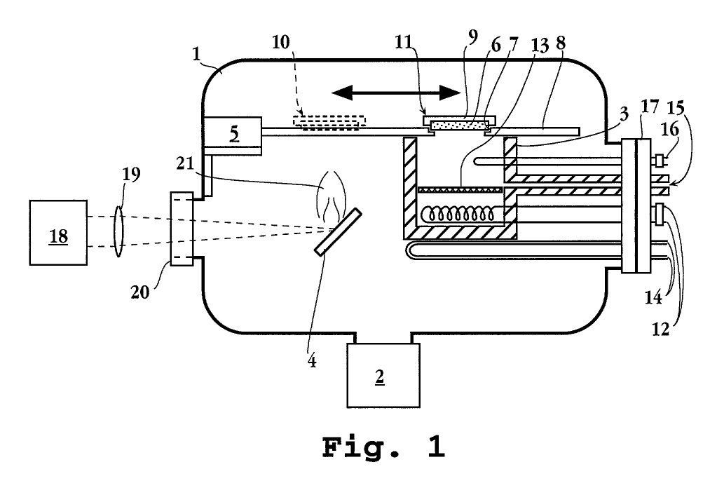

In one preferred embodiment, illustrated in FIG. 1, the substrate holder is attached to a linear motion actuator, which moves the holder periodically between two fixed positions. In either position, the substrate holder serves as a top lid for the high-pressure heater sub-chamber, leaving only a very narrow opening (typically less than 0.5 mm) between the two. In one of the two positions, “open”, it is placed outside of this can, under a lower pressure, and facing the PLD target and the laser-ablation plume. In this part of the film growth cycle, deposition occurs. In the other position, “closed”, the substrate is facing the high-pressure sub-chamber, and is consequently under a high pressure. In this part of the film growth cycle, the volatile gaseous species is loaded into the film. This could include oxidation of the more inert constituents, or incorporation of volatile elements such as Hg, Tl, Pb, Bi, K, Rb, etc. This process resembles the one used by Kinder et al [20] and by Matijasevic and Slycke [21] for deposition of large-area YBa₂Cu₃O₇ films. The key difference is that they use thermal co-evaporation and much lower pressure in both the deposition stage (typically 10⁻⁵ Torr), and the oxidation stage (typically 10⁻²-10⁻¹ Torr). In contrast, we are using PLD, and much (1,000-100,000 times) higher pressure. With respect to incorporation of volatile cations, the process resembles somewhat the two-stage, ex-situ growth of thin films of TlBaCaCuO [11] and HgBaCaCuO [4-9], whereby certain precursor oxides are deposited first onto a substrate, and in the second stage, the sample is encapsulated and annealed under a high Tl or Hg pressure. However, in that case, the volatile cations have to diffuse through the entire film thickness, which is accompanied with a gross change of the bulk crystalline structure, and requires very high temperature and pressure. In consequence, the films re-crystallize and generally end up being polycrystalline, having very rough surfaces, and inferior transport properties. In the present case, in one deposition step, only a fraction (typically between 0.01 and 0.5) of a molecular layer is deposited, and it is oxidized or loaded with the volatile cations immediately and before the deposition of the subsequent fraction of the molecular layer. In this way, oxidation or volatile cation loading occurs on a layer-by-layer basis. This obviates the need for gross bulk diffusion, permits film growth at reduced temperature, and provides for epitaxial growth, superior film morphology and physical properties.

A further important aspect of the present invention is that for most of the duty cycle, i.e., while it is in the “closed” position, the sample is effectively placed inside a black-body cavity, comprised of the high-pressure heater “can” and top lid or the “cap”9. This ensures good uniformity of the temperature over the entire substrate area.

The linear motion actuator occasionally and periodically moves the substrate holder from “closed” position to the “open” position and back. Generally, the duty cycle is low, say between 1:5 and 1:100, so that the substrate spends most of the time in the “closed” position. The period is adjustable and typically can be about 1 Hz, i.e., the substrate typically goes “open” once per second. The laser action is synchronized with the linear motion actuator so that the laser is fired when the sample is in the “open” position.

For example, if in one deposition event, 0.1 of a molecular layer of the desired compound is deposited, and the laser firing and substrate motion frequency is 1 Hz, it will take 10 seconds for one molecular layer, or about 2 nm film thickness. In one minute, one would deposit 12 nm, and in one hour, 0.72 microns. In principle, it is possible to increase the deposition rate significantly, by increasing the frequency (say to 10 Hz) and the laser energy density so that a larger fraction of a molecular layer is deposited in one burst.

It is possible to further improve the apparatus described above by adding a second high-pressure sub-chamber, so that the substrate with the film is periodically switched between two closed positions, passing on its way from one to another through the “open” position. In this way, it is easier to implement a regime where the duty cycle is low, and the fraction of time in the “open” position the smallest, as the substrate is passing through this position at the maximum speed, and decelerates while it is in the “closed” position.

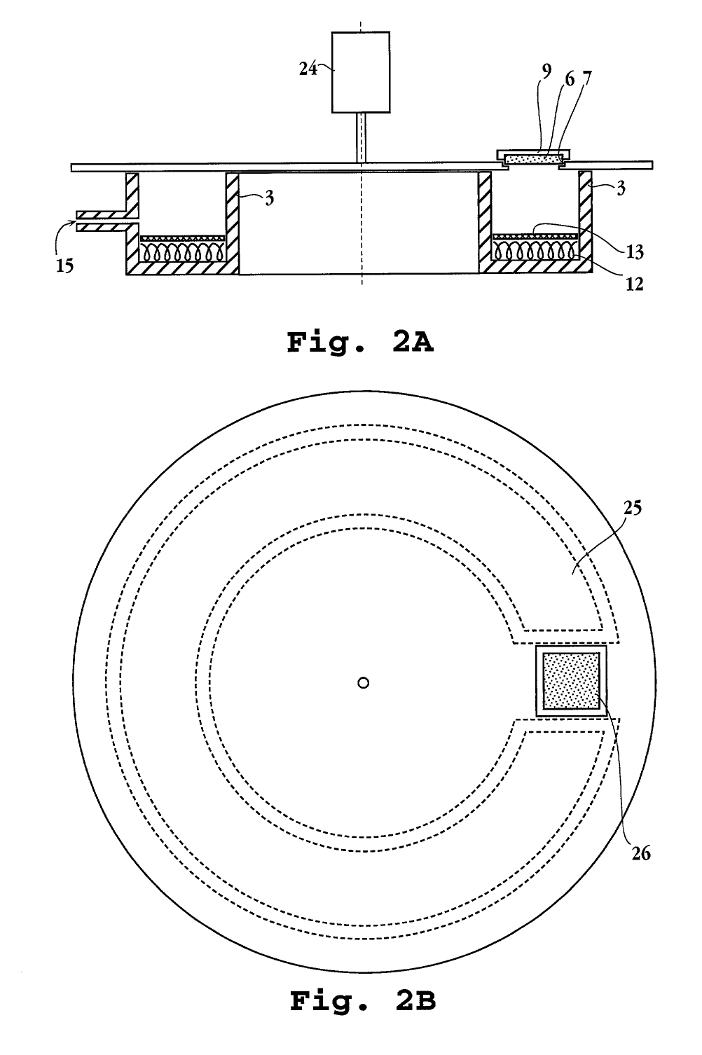

In another preferred embodiment of the present invention, illustrated in FIG. 2, the substrate is placed into a slot in the circular substrate holder, with an opening, so that most of the substrate's bottom surface is exposed, and covered with a “cap”. The linear motion actuator is replaced by an ordinary motor, with which the substrate holder can be rotated continuously, above the high-pressure can. The latter does not comprise a full circle, but is terminated in such a way as to leave an opening that corresponds to the substrate size, through which the material can be deposited onto the substrate. Thus, when the substrate holder is rotated, the substrate in effect switches between two positions, “open”, and “closed”. In either position, the substrate holder serves as a top lid for the high-pressure heater can, leaving only a very narrow opening (typically less than 0.5 mm) between the two.

Here also the duty cycle is low, say between 1:5 and 1:50, so that the substrate spends most of the time in the “closed” position. The period is adjustable and typically can be about 1 Hz, i.e., the substrate typically goes “open” once per second. Here, the frequency can be easily increased to 10 Hz, which corresponds to 600 rpm of the motor, and even higher. The laser firing is synchronized with this, so that the ablation bursts coincide with the substrate being in the “open” position, i.e., the ablated material is deposited onto the substrate.

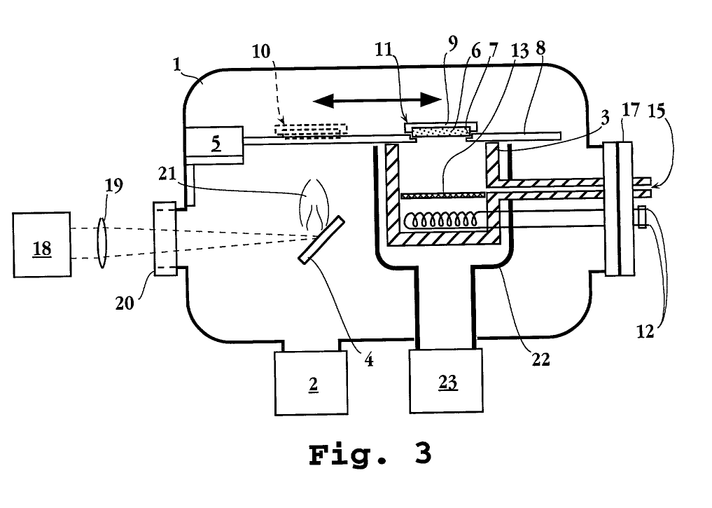

In yet another preferred embodiment of the present invention, the apparatus is further improved by using a two-stage differentially pumped linear-motion high-pressure heater assembly, as shown in FIG. 3.

This apparatus is rather similar to the one shown in FIG. 1; the new element here is the second, intermediary pressure sub-chamber, connected via a relatively large flange to the second pump. The opening between the top (open) side of this chamber and the substrate holder is a very narrow opening (typically less than 0.5 mm), so that in either the open or the closed position, or anywhere inbetween, the substrate holder serves as a top lid also for this intermediate-pressure sub-chamber.

In this way, one can achieve a large degree of differential pumping, e.g., about 100 mTorr in the main chamber, about 10 Torr in the intermediate sub-chamber, and 0.1-10 bar in the high-pressure sub-chamber. Significantly higher differential pumping ratios can also be obtained in this way.

The same improvement, i.e., adding a second differential-pumping stage, is also possible in the circular motion geometry as described above, and is included in the present invention as yet another preferred embodiment.

Critical to the proper functioning of the present apparatus, i.e., to achieving of a high differential pumping ratio, is to ensure a tight fit, i.e., a small distance between the two surfaces, of the substrate holder on one side and of one or two higher-pressure vessels, on the other. This is somewhat difficult because this tight fit must be achieved during the operation under high temperatures (say 500-1,000° C.). Other then precise machining, here we can employ one or more of the following improvements. First, one can allow the substrate holder to actually touch the high-pressure can under normal atmosphere, and let it move out by the pressure and gas flow, once the chamber is evacuated, under the bending force provided by the pressure difference. This bending force should be nearly offset by the substrate holder weight and the elastic force, so that the resultant opening is small and controllable.

Another possible improvement is to insert one or several cylindrical rollers between the substrate holder and the high-pressure can's surface, so that the substrate holder lays on these rollers. In this way, the opening between the substrate holder and the high-pressure chamber would be minuscule. This would allow for even higher differential pressure ratio, even with just a single stage apparatus.

Based on the teachings herein, it would be apparent to one of ordinary skill in the art that it is possible to invert all of the above structures upside-down, or even to place them at arbitrary angles. The present invention includes all such variations. One advantage of the geometry shown here is that one could easily place inside the high-pressure heaters a vessel containing liquid or powder of the desired volatile atomic species, instead of or in addition to supplying the gasses through the high-pressure gas inlets.

The above embodiments of the present invention all assume using a standard (say, tungsten or nickel-chrome) wire or tape heater, generally providing the temperature which is not only uniform across the sample but also constant in time during the film growth. However, in another embodiment of the present invention we can instead use a powerful lamp heater which can be ramped up and down very fast, generating flashes of heat directed at the sample. This resembles somewhat rapid thermal annealing (RTA) process used currently in semiconductor industry. A laser heater could also be used for the same purpose.

In this way, one can separate the film deposition process into two stages. First, one deposits the precursor material, which does not contain the volatile component, onto a cold substrate, say at or close to the room temperature. This will be amorphous in general. Next, one transfers the sample to the high-pressure chamber, where the sample is simultaneously exposed to a high pressure of the volatile species and to RTA. This should both induce incorporation of the volatile species and re crystallization of the film. The film is then cooled down to or near to the room temperature, and only then transferred to the “open” position, for deposition of another increment of the material. In this way, one ensures that there is no decomposition of the material, nor escape of the volatile species, while it is in the “open” position.

Again, an important novel feature here is that this process of precursor deposition/RTA plus loading with the volatile species occurs on a molecular layer basis, or even for a fraction of such layer at a time. This should ensure good epitaxy, smooth film surface, and superior transport and other physical properties.

As a further improvement of the present invention, it is possible to lower the substrate holder (or rise the high-pressure can) once the substrate is brought to the “closed” position, to seal the opening between the two. This would enable flushing the gas also in bursts, with the highest pressure being achieved when the sample is in the “closed” position. In this way, it is possible to further increase the difference in the pressure between the “open” and the “closed” sample positions.

As a further improvement of the present invention, instead of the molecular oxygen, it is possible to use ozone, atomic oxygen, oxygen plasma, NO₂, or some other stronger oxidant, or any mixture of two or more of these gases.

Referring now more specifically to FIG. 1, a pulsed laser deposition (PLD) system with a single-stage, linear-motion, high-pressure heater assembly is illustrated. A vacuum chamber 1 is provided with a pump 2 (such as a turbo-molecular pump provided with a backing mechanical pump), a plurality of flanges carrying optical windows, sample introduction port, feedthroughs for gas lines, water lines, and electrical connections, as well as mechanical supports for the high-pressure heater assembly 3, the target 4, and the linear motion actuator 5.

The substrate 6 is placed into a slot 7 in the substrate holder 8, with an opening, so that most of the substrate's bottom surface is exposed, and a top cover or “cap” 9. The substrate holder 8 can be moved between two positions, position 10 or “open”, and position 11 or “closed”, by means of the linear motion actuator 5. In either position, the substrate holder 8 serves as a top lid for the high-pressure heater sub-chamber 3, leaving only a very narrow opening (typically less than 0.5 mm) between the two.

The high-pressure sub-chamber 3 is further provided with a heater 12, possibly a removable shield 13 of good thermal conductivity and inert to the chemicals involved, a water-cooling assembly 14, one or more gas inlets 15, and possibly a temperature sensor 16 such as a thermocouple. To connect these, the chamber 1 is provided with one or more feedthroughs 17 for the electrical connections for the heater 12, the water lines 14, the gas lines 15, and the thermocouple 16.

By the virtue of this construction, including the “cap” 9, in the “closed” position 11, the substrate is essentially enclosed in a black-body cavity. This ensures good uniformity of the temperature.

The linear motion actuator occasionally and periodically moves the substrate holder 8 from the “closed” position 11 to the “open” position 10 and back. Generally, the duty cycle is low, say between 1:10 and 1:100, so that the substrate spends most of the time in the “closed” position 11. The period is adjustable and typically can be about 1 Hz, i.e., the substrate typically goes “open” once per second. The laser firing is synchronized with this, so that the ablation bursts coincide with the substrate being in the “open” position, i.e., the ablated material is deposited onto the substrate.

The light beam from a laser 18 is focused, by means of a lens 19, through an optical port 20, onto the target 4. The latter can be a pressed-ceramic target, or a single crystal, of the desired composition. The laser 18 can be an excimer laser, or some other laser with enough power to cause ablation of the target, and generate a plume 21. The direction of the light beam and the orientation of the target 4 can be adjusted so that the plume 21 is aimed at the substrate 6 when the latter is in the “open” position 10.

Referring now more specifically to FIG. 2, a single-stage, circular-motion, high-pressure heater assembly is illustrated. Here, substrate 6 is placed into a slot 7 in a circular substrate holder, with an opening, so that most of the substrate's bottom surface is exposed, and covered with “cap” 9. The circular substrate holder can be rotated continuously, above the high-pressure can. The latter does not comprise a full circle, but is terminated in such a way as to leave an opening that corresponds to the substrate size, through which the material can be deposited onto the substrate. Thus, when the circular substrate holder is rotated, the substrate 6 in effect also switches between two positions: an “open” position where it is outside the high-pressure can and a “closed” position where it is facing the high-pressure sub-chamber and is consequently exposed to a high pressure. In either position, the substrate holder serves as a top lid for the high-pressure heater can, leaving only a very narrow opening (typically less than 0.5 mm) between the two.

The high-pressure sub-chamber or can is further provided with a heater, a removable shield 13 of good thermal conductivity and inert to the chemicals involved, one or more gas inlets, a water-cooling assembly (not shown), a temperature sensor such as a thermocouple (not shown), etc. This high-pressure sub-chamber is placed inside a vacuum chamber provided with pumps, viewports, feedthroughs, target holder, etc. (not shown). An excimer laser or another powerful laser (not shown) is used to ablate the target and deposit the film onto the substrate, as in FIG. 1.

Here also the duty cycle is low, say between 1:5 and 1:50, so that the substrate spends most of the time in the “closed” position. The period is adjustable and typically can be about 1 Hz, i.e., the substrate typically goes “open” once per second. The laser firing is synchronized with this, so that the ablation bursts coincide with the substrate being in the “open” position, i.e., the ablated material is deposited onto the substrate.

Referring now more specifically to FIG. 3, a pulsed laser deposition (PLD) system with a two-stage differentially pumped linear-motion high-pressure heater assembly is illustrated. This apparatus is rather similar to the one shown in FIG. 1, except that here we have added a second differential pumping stage.

Vacuum chamber 1 is provided with pump 2, a plurality of flanges carrying optical windows, sample introduction port, feedthroughs for gas lines, water lines, and electrical connections, as well as mechanical supports for high-pressure heater assembly 3, target 4, and linear motion actuator 5.

Substrate 6 is placed into slot 7 in substrate holder 8, with an opening, so that most of the substrate's bottom surface is exposed, and the top cover or “cap” 9. Substrate holder 7 can be moved between the “open” and “closed” positions by means of linear motion actuator 5, as in FIG. 1. In either position, substrate holder 8 serves as a top lid for high-pressure heater sub-chamber 3, leaving only a very narrow opening (typically less than 0.5 mm) between the two.

High-pressure sub-chamber 3 is further provided with a heater 12, a removable shield 13 of good thermal conductivity and inert to the chemicals involved, a gas inlet 15, a water-cooling assembly (not shown), and a thermocouple (not shown). To connect these, chamber 1 is provided with one or more feedthroughs for the electrical connections for heater 12, gas lines 15, the water lines, and the thermocouple.

The new element here is the second, intermediary pressure sub-chamber 22, connected via a relatively large tube end flange to the second pump 23. The opening between the top (open) side of this sub-chamber and substrate holder 8, is very narrow (typically less than 0.5 mm), so that in either the “open” or the “closed” position, or anywhere in-between, substrate holder 8 also serves as a top lid for this intermediate-pressure sub-chamber 22.

In this way, one can achieve a large degree of differential pumping, e.g., ca. 100 mTorr in the main chamber, ca. 10 Torr in the intermediate sub-chamber, and ca. 1,000 Torr in the high-pressure sub-chamber.

Like in FIG. 1, in the “closed” position, the substrate here is essentially enclosed in a black-body cavity, which ensures good uniformity of the temperature.

The linear motion actuator occasionally and periodically moves substrate holder 8 from the “closed” position to the “open” position and back. Generally, the duty cycle is low, say between 1:10 and 1:100, so that the substrate spends most of the time in the “closed” position 11. The period is adjustable and typically can be about 1 Hz, i.e., the substrate typically goes “open” once per second. The laser firing is synchronized with this, so that the ablation bursts coincide with the substrate being in the “open” position, i.e., the ablated material is deposited onto the substrate. Like in FIG. 1, the light beam from a laser 18 is focused, by means of a lens 19, through an optical port 20, onto the target 4. The later can be a pressed-ceramic target, or a single crystal, of the desired composition. The laser 18 is an excimer laser, or some other laser with enough power to cause ablation of the target, and generate a plume 21. The direction of the light beam and the orientation of the target 4 can be adjusted so that the plume 21 is aimed at the substrate 6 when the latter is in the “open” position.

What is claimed:

1. A pulsed laser deposition system for in-situ deposition of thin films of one or more high-temperature superconductor (HTS) compounds on a substrate, comprising:
means for depositing at least one HTS compound, produced from laser ablation of a target, on the substrate;
a vacuum chamber adapted to support and maintain the target at a relatively low pressure;
a high-pressure sub-chamber provided with one or more gas supply inlets and a heater;
a substrate holder adapted to support the substrate; and
means for periodically moving the substrate holder between an open position wherein the substrate is subjected to the deposition composition at the relatively low pressure of the vacuum chamber and a closed position wherein the substrate is positioned over the open end of the high-pressure sub-chamber and exposed to a relatively high partial pressure of a gaseous oxygen-containing mixture or a relatively high vapor pressure of one or more volatile metallic elements;
wherein the depositing means is controlled to deposit onto the substrate in relatively short intervals, each deposit interval being followed by a substantially longer interval during which the deposited composition is permitted to undergo re-crystallization and structural relaxation, and wherein the moving means is controlled to move the substrate between the open and closed positions, such that the substrate is alternately subjected to the deposition composition and exposed to the high-pressure sub-chamber on a layer-by-layer basis.

2. The system of claim 1, further comprising a pump operably connected to the vacuum chamber to maintain the relatively low pressure therein at about 100 mTorr.

3. The system of claim 1, further comprising a first pump operably connected to the vacuum chamber, an intermediate pressure chamber in which the high-pressure sub-chamber is positioned, and a second pump operably connected to the intermediate pressure chamber, wherein the first and second pumps operate to maintain a pressure of about 100 mTorr in the vacuum chamber, a pressure between about 10 Torr in the intermediate chamber, and a pressure between about 0.1 and about 10 bar in the high-pressure sub-chamber.

4. The system of claim 1, wherein the deposit interval is about 1 to about 10 nanoseconds and the substantially longer interval is between 1 millisecond and 10 seconds.

5. The system of claim 1, wherein the substrate holder serves as a lid for the open end of the high-pressure sub-chamber.

6. The system of claim 1, wherein the moving means comprises a linear motion actuator that periodically moves the substrate holder between the open and closed positions.

7. The system of claim 6, wherein the ratio of the time in which the substrate holder is held in the open position to the time in which the substrate holder is held in the closed position is in the range of about 1:10 to about 1:100.

8. The system of claim 1, wherein the substrate holder is generally circular and the moving means comprises a motor operably connected to the circular substrate holder to rotate it continuously, such that the substrate is alternately in the closed position over the open end of the high-pressure chamber for a first period of time and in the open position subjected to the deposition composition for a second substantially shorter period of time.

9. The system of claim 8, wherein the ratio of the first and second periods of time is in the range between about 1:5 to about 1:50.

10. The system of claim 1, wherein the gaseous oxygen-containing mixture comprises molecular oxygen, ozone, atomic oxygen or NO₂, or a mixture of these gases.

11. The system of claim 1, wherein the one or more volatile elements comprises Hg, Tl, Pb, Bi, K or Rb.

12. A cyclic method for in-situ deposition of a thin film of one or more high-temperature superconductor (HTS) compounds on a substrate, said method comprising:
depositing at least one HTS compound, produced by laser ablation of a target, on a substrate in intervals between about 10 and about 100 nanoseconds, each deposition interval being followed by a passive interval of between about 1 millisecond and about 10 seconds to allow for re-crystallization and structural relaxation of the deposited composition;
maintaining the target at a relatively low pressure;
exposing the deposited composition on the substrate to a relatively high partial pressure of a gaseous oxygen-containing mixture or a relatively high vapor pressure of one or more volatile metallic elements; and
alternately repeating the depositing and exposing steps on a layer-by-layer basis.

13. The method of claim 12, wherein the relatively low pressure at which the laser ablation target is maintained between about 0.1 mTorr and about 10 Torr.

14. The method of claim 13, wherein the relatively low pressure at which the laser ablation target is maintained is preferably about 100 mTorr.

15. The method of claim 12, wherein the relatively high partial pressure to which the deposited composition is exposed is in the range of about 0.1 to about 10 bar.

16. The method of claim 12, wherein the time ratio between the depositing and exposing steps are about 1:10 to about 1:100.

17. The method of claim 12, wherein the gaseous oxygen-containing mixture comprises molecular oxygen, ozone, atomic oxygen and/or NO₂.

18. The method of claim 12, wherein the one or more volatile elements comprises Hg, Tl, Pb, Bi, K or Rb.
